(19) United States
(12) Patent Application Publication
(10) Pub. No.: US 2009/0106233 A1
(43) Pub. Date: Apr. 23, 2009

(54) QUERY ENGINE INTERPRETER AND PRIORITIZATION ENGINE

(76) Inventor: John W. Veenstra, Holton, MI (US)

Correspondence Address: MERCHANT & GOULD PC, P.O. BOX 2903, MINNEAPOLIS, MN, 55402-0903, US

(21) Appl. No.: 12/196,051

(22) Filed: Aug. 21, 2008

Related U.S. Application Data
(60) Provisional application No. 60/957,904, filed on Aug. 24, 2007.

(51) Int. Cl. G06F 17/30

(52) U.S. Cl. 707/5; 707/3; 707/E17.014; 707/E17.017; 707/E17.018

(57) ABSTRACT

A method for refining a search query includes receiving a query from a user, submitting at least one question to the user based on information provided in the query, and receiving an answer to the question from the user. The method also includes refining the query based on the answer received from the user, querying the database using the refined query to identify a subset of records tagged with categories relevant to the query, and delivering search results to the user.

This application claims the benefit of U.S. Patent Application Ser. No. 60/957,904 filed on Aug. 24, 2007, the entirety of which is hereby incorporated by reference.

### BACKGROUND

Over the last decade, the Internet has grown tremendously. It is currently estimated that over 1.1 billion people use the Internet. Given the vast amounts of information contained on the World Wide Web, users often employ search engines to navigate their way to web pages containing information that they seek.

Search companies typically have at least two databases from which content is delivered. One database is an index of web content, and the other is an advertising database. Each search company develops proprietary search algorithms to search the databases in an effort to differentiate the company's search product. For example, Google uses “page rank” as the key method to determine the importance or ranking of their web search results. However, such search algorithms provide an “average” search result, and do not give the user the flexibility to define what is important to the user on any particular search.

As a result of these algorithms, search results are often inaccurate or inadequate. As only about thirty percent of search results are adequate, there is a need for a more accurate searching systems and methods.

### SUMMARY

Examples described herein relate to systems and methods for refining a search query. In some embodiments, a method includes: receiving a query from a user; submitting at least one question to the user based on information provided in the query; receiving an answer to the question from the user; refining the query based on the answer received from the user; querying the database using the refined query to identify a subset of records tagged with categories relevant to the query; and delivering search results to the user.

The summary is not intended to describe each disclosed embodiment or every implementation. The figures and the detailed description that follows describe further embodiments. While certain embodiments will be illustrated and described, the present disclosure is not limited to use in such embodiments.

### DESCRIPTION OF THE DRAWINGS

FIG. 1 is a schematic representation of a communications system.

FIG. 2 is a schematic representation of the communications system of FIG. 1.

FIG. 3 is another schematic representation of the communications system of FIG. 1.

FIG. 4 is a schematic representation of the communications system of FIG. 3.

FIG. 5 is another schematic representation of the communications system of FIG. 3.

FIG. 6 is a flowchart of an exemplary method for refining a query.

FIG. 7 is a flowchart of an alternate exemplary method for refining a query.

FIG. 8 is a flowchart of an alternate exemplary method for refining a query.

FIG. 9 is a flowchart of an exemplary method for determining the adequacy of search results.

FIG. 10 is a fragmentary schematic representation of a database.

FIG. 11 is an exemplary method for creating a record in the database of FIG. 10.

FIG. 12 is an exemplary method for querying the database of FIG. 10 to identify relevant records.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

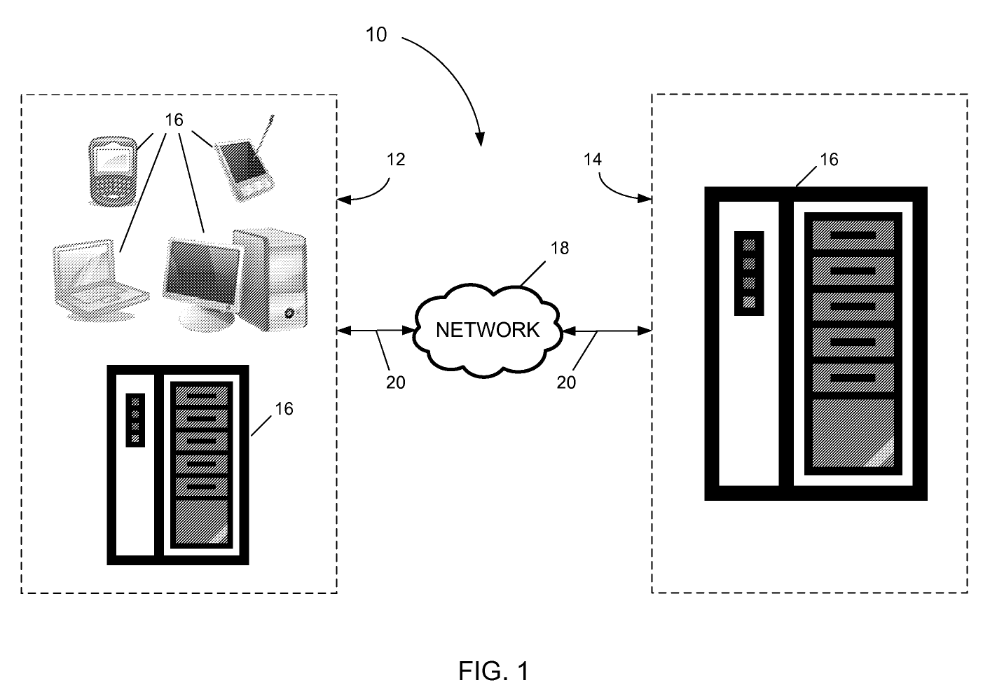

Referring now to FIG. 1, a schematic representation of a communications system 10 is shown. In the subject embodiment, the communications system 10 includes a client system 12, and a host system 14. The client system 12 and the host system 14 can take the form of any of one or more of a plurality of communication devices 16. Such communication devices 16 include, but are not limited to, mobile devices such as cellular phones and personal digital assistants (PDAs) and computer systems such as laptops, desktops, servers, and mainframes.

A communication network 18 provides direct or indirect communication paths 20 between the client system 12 and the host system 14. In the subject embodiment, the communication network 18 is the Internet and the communication paths 20 include, but are not limited to, wired, wireless, cable, or satellite paths. The scope of the present disclosure is, however, not limited to the communication network 18 being the Internet, as other communication networks 18 including but not limited to personal area networks, local area networks, wide area networks, or satellite networks can also be used.

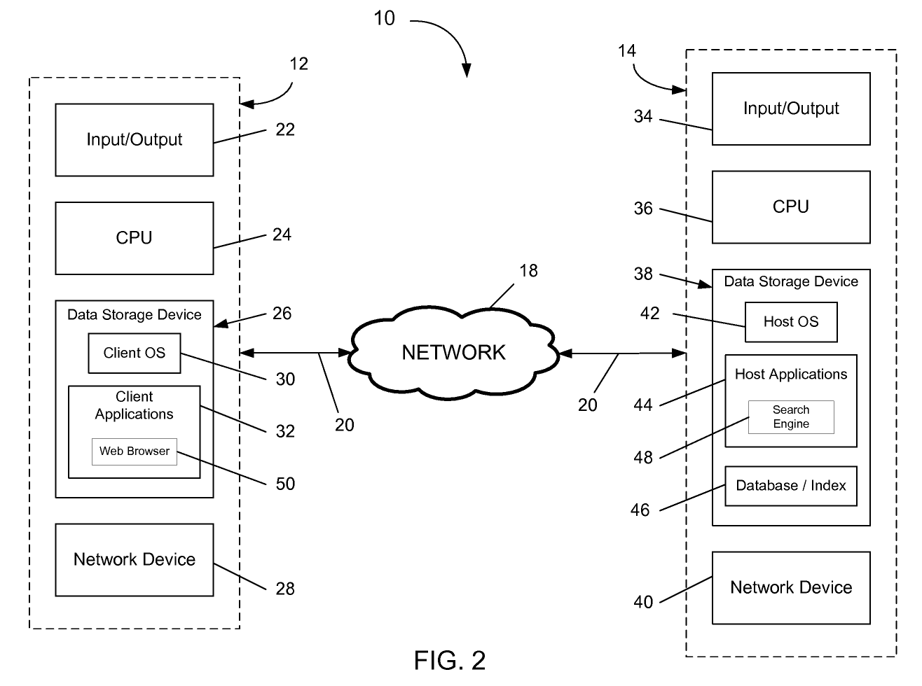

Referring now to FIG. 2, typical elements of the client system 12 and the host system 14 are shown schematically. In the subject embodiment, the client system 12 is a computer device that includes an input/output device 22, a central processing unit (“CPU”) 24, a data storage device 26, and a network device 28.

Typical input/output devices 22 include, but are not limited to, keyboards, mice, displays, microphones, speakers, disk drives, CD-ROM drives, and flash drives. The input/output device 22 provides an interface between a user and the CPU 24. The user inputs commands and/or information into the input device 22, which is then interpreted and processed by the CPU 24. Results or feedback from the CPU 24 is then transmitted to the user through the output device 22.

The data storage device 26 provides for data retention. The data storage device 26 can include volatile and nonvolatile, removable and non-removable media implemented in any method or technology for storage of information, such as computer readable instructions, data structures, program modules, or other data. System memory, removable storage, and non-removable storage are all examples of computer readable storage media that can make up the data storage device 26. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store desired information. In a typical client system 12, the data storage device 26 is accessible by the CPU 24. Among the plurality of information stored on the data storage device 26 is a client operating system (“OS”) 30 and client applications 32.

The client OS 30 is a program that manages the hardware and software resources of the client system 12. A few of the many tasks performed by the client OS 30 include controlling and allocating memory resources, prioritizing system requests, controlling input and output devices, facilitating networking and managing file systems. The client OS 30 may include, but is not limited to, Microsoft Windows, Mac OS, Linux, Palm OS, and Symbian OS.

Client applications 32 utilize the resources of the client system 12 to directly perform tasks specified by the user. Client applications 32 can be business applications or personal applications. A few of the more typical client applications 32 include, but are not limited to, word processors, spreadsheets, calendars, e-mail applications, short message service (SMS), and web browsers.

The network device 28 enables the client system 12 to send and receive data to/from the host system 14 through the communications network 18. One example of a typical network device 28 is a modem such as a voiceband modem, DSL modem, or cable modem. It will be understood, however, that the scope of the present disclosure is not limited to the use of a modem.

Referring still to FIG. 2, the host system 14 includes a host input/output device 34, a host CPU 36, a host data storage device, generally designated 38, and a host network device 40. The host input/output device 34, the host CPU 36, the host data storage device 38, and the host network device 40 have similar functions to the devices described with regard to the client system 12. However, in addition to a host OS 42 and host applications 44, the host data storage device 38 may include a database/index 46.

The database/index 46 is a structured collection of information that is stored in the host data storage device 38. Information in the database/index 46 is retrieved using applications such as database management systems and/or information retrieval systems in response to queries. Database management systems manage and query databases, while information retrieval systems search documents, information in documents, metadata that describes documents, and databases. Examples of database management systems include, but are not limited to, Oracle, My SQL, PostgreSQL, DB2, Microsoft Access, and Microsoft SQL. Examples of information retrieval systems include, but are not limited to, search engines such as Google, Yahoo, AltaVista, and Ask.com.

A search engine 48 is a host application 44 that is stored on the host system 14. Search engines 48 are commonly used to search for web pages, documents, and other resources that are available on the World Wide Web through the Internet. Using a web browser 50 such as Internet Explorer, Netscape, Safari, or Mozilla Firefox, the user of the client system 12 is able to navigate to a desired search engine 48 and enter a query based on the informational needs of the user.

In order to provide faster response times to queries, the host data storage device 38 stores information about web pages in indexes 46. In some embodiments, the information stored in the indexes is further organized based on categories, as described further below (see index 46′). In order to respond to a query from the client system 12, search engine 48 searches indexes 46, which look for all words and/or categories in the query. For example, if a query for “Chicago restaurants” is entered, the web search engine 44 will search the indexes 46 on the host system 14 for all web pages having the terms “Chicago” and/or “restaurants.”

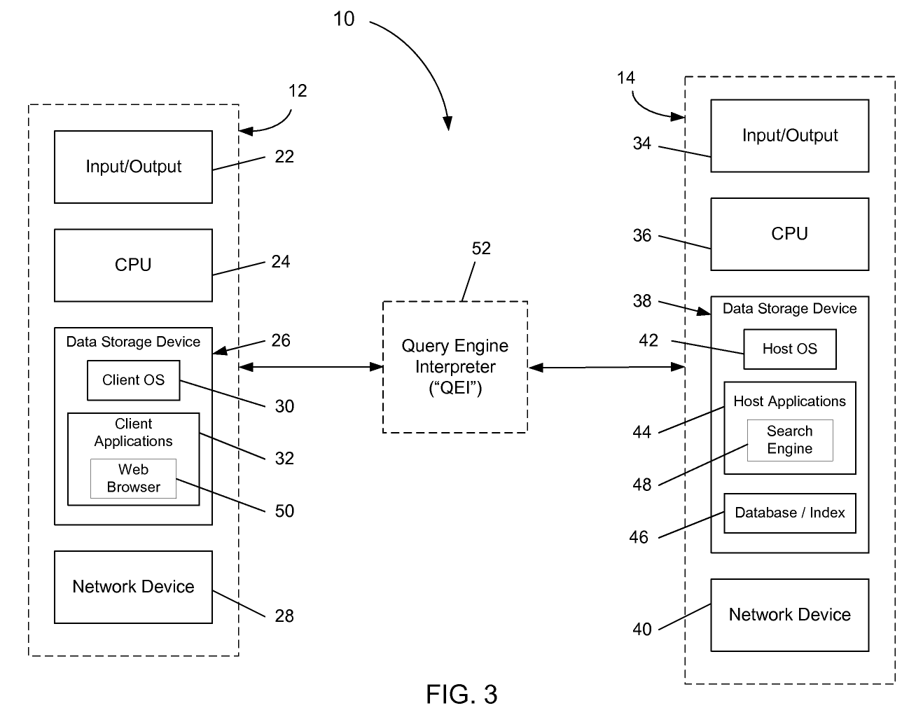

Referring now to FIGS. 3-5, a query engine interpreter 52 (“QEI”) will be described. In the subject embodiment, the QEI 52 is a software application that minimizes the occurrence of inaccuracies in search results by interacting with the client system 12 and the host system 14 to refine a query submitted by the user. In the subject embodiment, the QEI 52 refines the query submitted by the user based on responses from the user to questions posed by the QEI 52 so as to refocus the scope of the search performed by the search engine 48.

In the subject embodiment, the QEI 52 communicates with the client system 12 and with the host system 14. As a software application, the QEI 52 can be installed on the client system 12, the host system 14, or some other system that is in communication with the client system 12 and the host system 14.

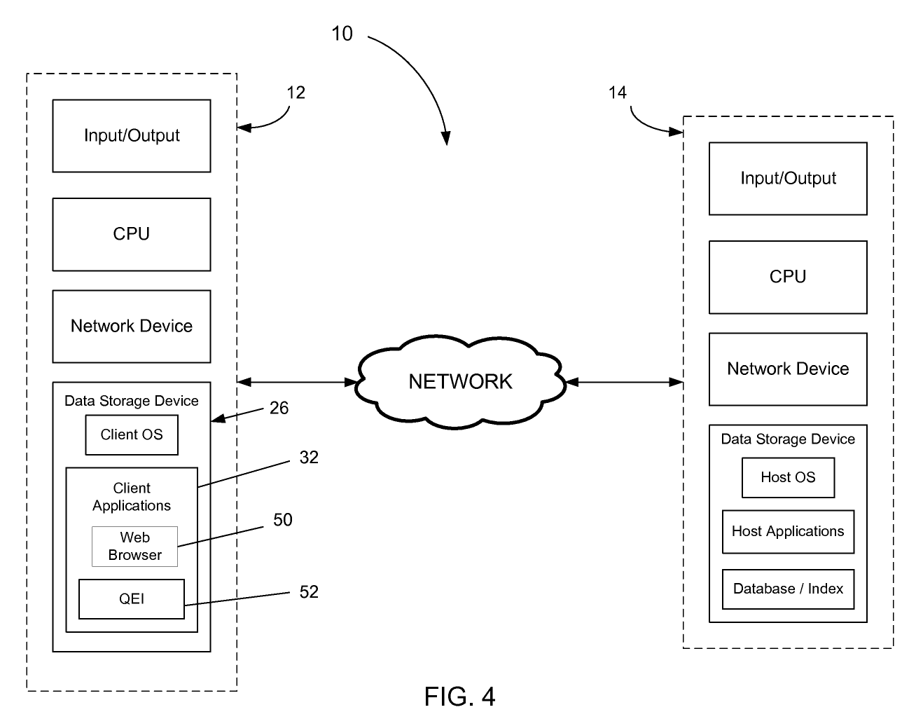

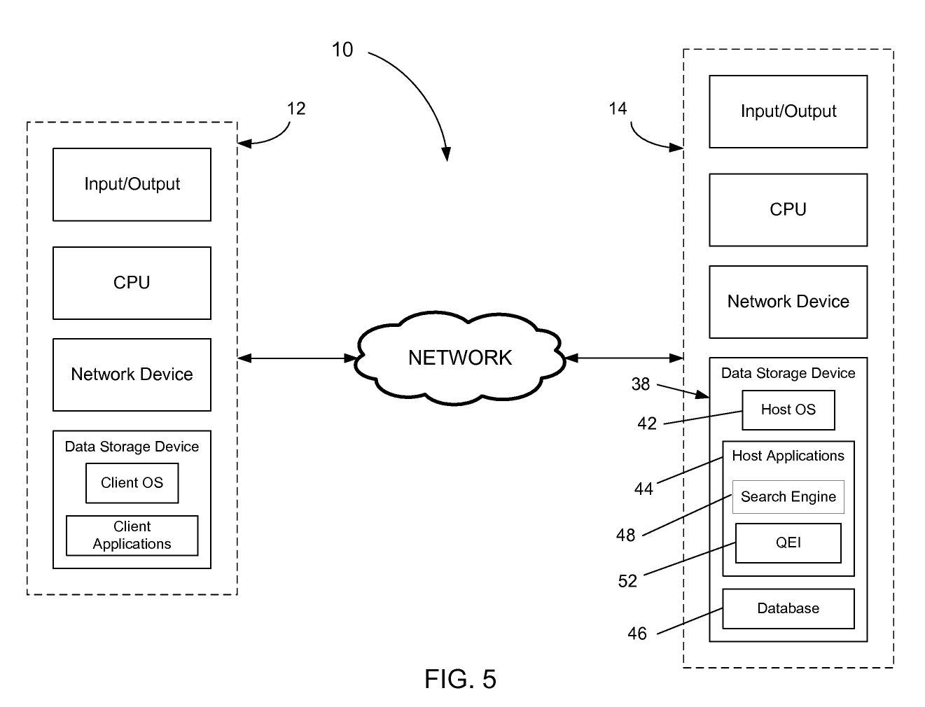

FIG. 4 is a schematic representation of the QEI 52 installed as a client application 32 on the data storage device 26 of the client system 12. FIG. 5 is a schematic representation of the QEI 52 installed as a host application 44 on the host data storage device 38 of the host system 14. While the QEI 52 has been shown on the client system 12 and the host system 14, the scope of the present disclosure is not limited to the QEI 52 being installed on the client system 12 or the host system 14. For example, in other embodiments, the QEI 52 can be an intermediate website hosted by a third party that acts as an intermediary between the client system 12 and the host system 14. Other configurations are possible.

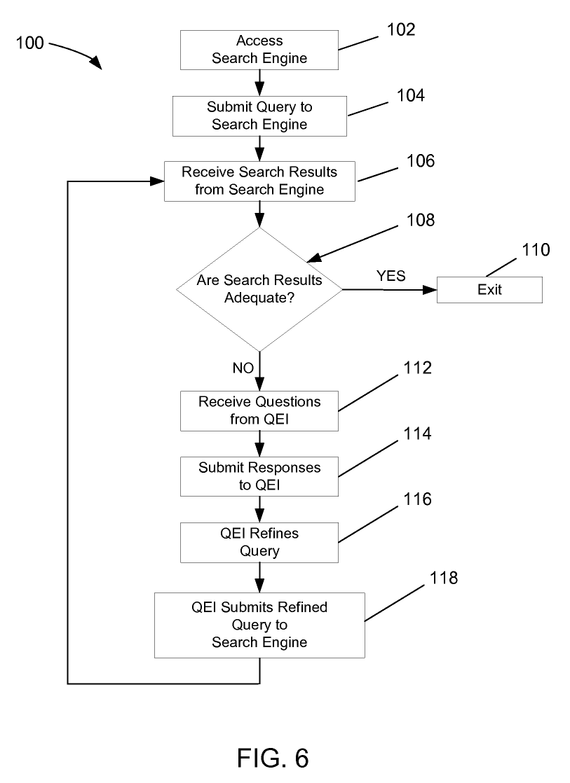

Referring now to FIG. 6, an example method 100 for refining a query using the QEI 52 will be described. As the QEI 52 is an application that could be initiated by the host system 14 or by the user of the client system 12, the method 100 will be described with regard to each initiation approach. In the host system initiation approach, the user of the client system 12 launches the web browser 50 stored on the data storage device 28 and accesses the search engine 48 of the host system 14 in step 102. In step 104, the user submits a query to the search engine 48. In the subject embodiment, this step 104 is done by entering keywords that are representative of the informational needs of the user into a text box on the web page of the search engine 48. The search engine 48 receives the submitted query and performs a search of the indexes 46 of the host system 14 based on the submitted keywords. The individual results of that search are then ranked using predefined algorithms on the host system 14. The client system 12 then receives a list of ranked search results from the host system 14 in step 106.

A determination, generally designated 108, of the adequacy of the search results, which will be described in greater detail subsequently, is made based on the actions of the user of the client system 12 with regard to the search results. If the search results are adequate, the user may either exit 110 the search engine 48 or enter a new search based on different informational needs. If, however, the search results are inadequate, the search engine 48 launches the QEI 52.

The QEI 52 receives the user's originally submitted query from the search engine 48. Based on this originally submitted query, the QEI 52 generates questions that are to be posed to the user of the client system 12. In one embodiment, the purpose of the questions is to assist the QEI 52 in determining the informational needs of the user of the client system 12. In another embodiment, the purpose of the questions is to assist the QEI 52 in prioritizing the sequence of the search. In another embodiment, the purpose of the questions is to assist the QEI 52 in clarifying any vagueness or ambiguities in the originally submitted query.

The questions generated by the QEI 52 can be either “open” or “closed” type questions. An open-type question is a question that elicits a multiword response from the user of the client system 12. A closed-type question, on the other hand, is a question that elicits a single word response, such as “yes” or “no.”

In one embodiment, the questions from the QEI 52 are based a plurality of areas including, but not limited to, specific geographical areas, languages, specific events (e.g., birthdays, weddings, vacations, etc.), specific time frames (e.g., between 1967 and 1972, before World War I, etc.), specific databases (e.g., telephone directories, etc.), and specific search engines (Google, Yahoo, Ask.com, etc.). The responses to these questions are then used by the QEI 52 in order to narrow or broaden the user's query.

In step 112, the user of the client system 12 receives questions from the QEI 52 concerning the submitted query. In one embodiment, the questions are submitted to the user of the client system 12 through a dialog box. For example, if the user had previously submitted the query “Chicago doctors” and received inadequate search results from the search engine 48, the user of the client system 12 may receive a question from the QEI 52 such as “Are you more interested in geography or the general topic of doctors?”

In step 114, the user of the client system 12 would submit a response to the question to the QEI 52. In one embodiment, the responses are made by entering text into a text box in the dialog box. In another embodiment, the responses are made through radio buttons that allow the user to choose one response from a list of predefined responses. In yet another embodiment, the responses are made through check boxes that allow the user to choose multiple responses from a list of predefined responses.

In the example above, the user submits a response that the user is more interested in “geography.” After receiving the response from the user, the QEI 52 can pose further questions to the user of the client system 12, such as “are you more interested in a particular specialty area of doctors.”

In the subject embodiment, the QEI refines the query based on the responses received from the user of the client system 12 in step 116. In the example above, if the user had submitted the query “Chicago doctors” and submitted a response that geography was more important than the general topic of doctors, the QEI could refine the query such that the search engine 48 would minimize all search results relative to doctors except that associated with a particular geography.

In step 118, the QEI 52 submits the refined query to the search engine 48. The search engine 48 receives the submitted refined query and performs a search of the indexes 46 of the host system 14, after which the user of the client system 12 receives the results of the search based on the refined query.

At this point, the determination 108 concerning the adequacy of the search results is again made. If the search results are adequate, the user may either exit 110 the search engine 48 or enter a new search based on different informational needs. If the search results are inadequate, the QEI 52 will pose further questions to the user of the client system 12 to further refine the query.

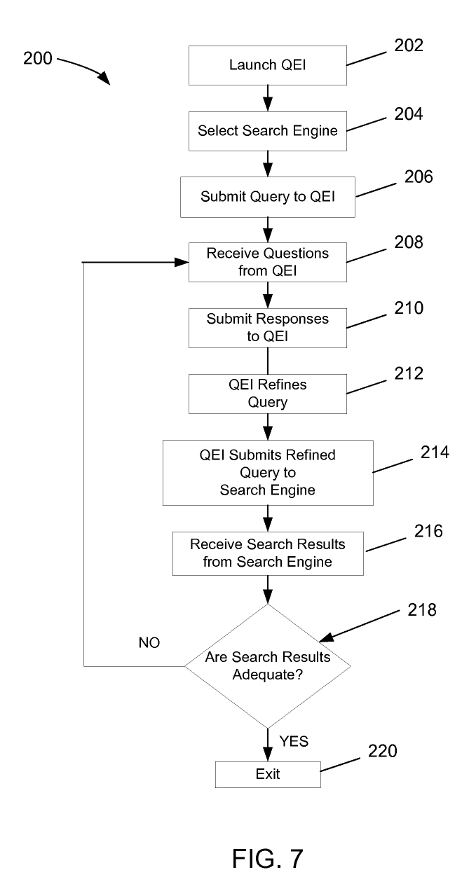

Referring now to FIG. 7, a method 200 for refining a query using the QEI 52 will be described with the QEI 52 being initiated by the user of the client system 12. In this method, the user of the client system 12 initiates the QEI 52 in step 202. In the subject embodiment, the QEI 52 may be a client application 32 stored on the data storage device 26 of the client system 12 or a web application which is accessible through the web browser 50.

The QEI 52 prompts the user of the client system 12 to select an individual search engine 48 or multiple search engines 48 in step 204. It will be understood, however, that step 204 could occur at any time prior to the submission of the query to the search engine 48. A query is then submitted to the QEI 52 by the user of the client system 12 in step 206. In the subject embodiment, the query would be submitted with keywords entered in a text box on the web page of the search engine 48. It will be understood, however, that the query could be submitted in response to a question posed by the QEI 52 to the user of the client system 12.

In step 208, the user of the client system 12 receives questions from the QEI 52 concerning the submitted query. In the subject embodiment, these questions are submitted to the user through a dialog box. The user of the client system 12 submits responses to those questions in step 210. In step 212, the QEI 52 uses these responses to refine the originally submitted query.

The QEI 52 submits the refined query to the search engine 48 in step 214. Using the refined query, the search engine 48 performs a search of the indexes 46 stored on the host data storage device 38 and returns search results to the user of the client system 12 in step 216. At an operation 218, a determination of the adequacy of the search results, which will be described in greater detail subsequently, is made based on the actions of the user of the client system 12 with regard to the search results. If the search results are adequate, the user may either exit 220 the search engine 48 or enter a new search based on different informational needs. If, however, the search results are inadequate, the QEI 52 would return to step 208 in the method 200 and submit new questions to the user concerning the query.

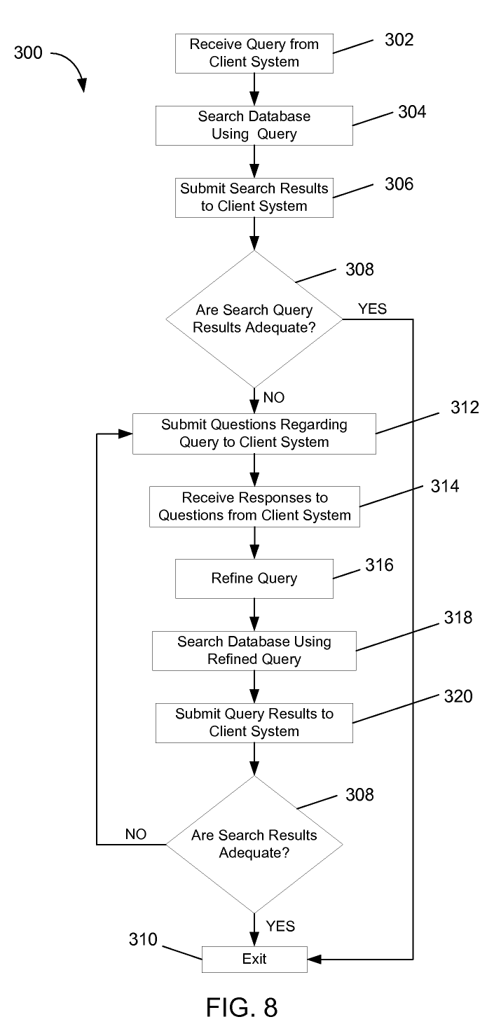

Referring now to FIG. 8, a method 300 for refining a query using a search engine that incorporates features of the QEI 52 will be described. In the subject embodiment, the search engine 48 of the host system 14 receives a query from the client system 12 in step 302. In step 304, the search engine 48 performs a search of the indexes 46 using the submitted query. The results of that search are then ranked by the search engine 48 and submitted to the user of the client system 12 in step 306.

A determination, generally designated 308, of the adequacy of the search results is made based on the actions of the user of the client system 12 with regard to the search results. If the search results are adequate, the user may either exit 310 the search engine 48 or enter a new search based on different informational needs. If, however, the search results are inadequate, the search engine 48 submits questions regarding the originally submitted search to the user of the client system 12 in order to assist the search engine in clarifying the informational needs of the user of the client system 12 or in prioritizing the sequence of the search in step 312.

In step 314, the search engine 48 receives responses from the user of the client system 12. The search engine 48 uses these responses to refine the originally submitted query in step 316. Using the refined query, the search engine 48 searches the indexes 46 of the host system 14 in step 318 and submits the search results to the user of the client system 12 in step 320. The determination 308 of the adequacy of the search results is then made again.

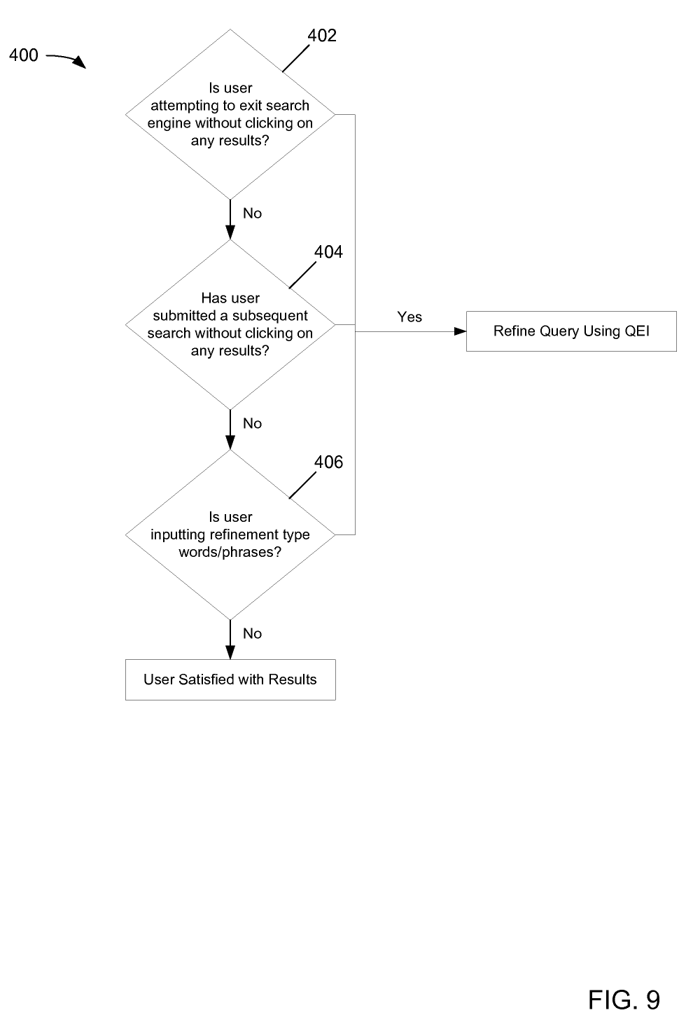

Referring now to FIG. 9, an example method 400 for making the determination 108, 218, 308 of the adequacy of the search results is described. In FIG. 8, there are four example events shown which, if met, will trigger the QEI 52 to submit query refinement questions to the user of the client system 12.

In event 402, the user attempts to exit the search engine 48 without selecting any of the returned search results, which are based on a submitted query. As this action by the user has a tendency to suggest inadequacy of the search results, the QEI 52 would then submit questions to the user of the client system 12 to determine whether the user found the search results adequate. If the search results were inadequate, the QEI 52 would begin submitting questions to the user to refine the originally submitted query.

In event 404, if the user has not attempted to exit the search engine 48 but has submitted another query after receiving the search results without selecting any of the returned search results, the submission of the subsequent query will trigger the QEI 52 to submit questions to the user of the client system 12 to determine whether the user found the search results adequate. If the user responds that the search results were inadequate, the QEI 52 would begin submitting questions to the user to refine the originally submitted query. Event 404 can be triggered immediately upon a subsequent submission of an additional query or after a predefined number of subsequent submissions of additional search queries, such as two, three, or four submissions.

In event 406, the QEI 52 will submit questions to the user of the client system 12 to determine whether the user found the search results adequate if the user enters words or phrases into the text box of the search engine 48 that are refinements of the words or phrases in the originally submitted query (e.g., included additional terms to the original query, included generic or specific terms that are related to terms in the original query, etc.). If the user responds that the search results were inadequate, the QEI 52 would begin submitting questions to the user to refine the originally submitted query. Event 406 can be triggered immediately upon a subsequent resubmission of an additional query or after a predefined number of subsequent re-submissions of additional search queries, such as two, three, or four re-submissions.

In an alternate embodiment of the example method 400 for making the determination 108, 218, 308 of the adequacy of the search results, the QEI 52 would begin submitting questions to the user to refine the originally submitted query upon the occurrence of any one of the events 402, 404, 406, rather than first submitting a question to the user as to whether the search results were adequate.

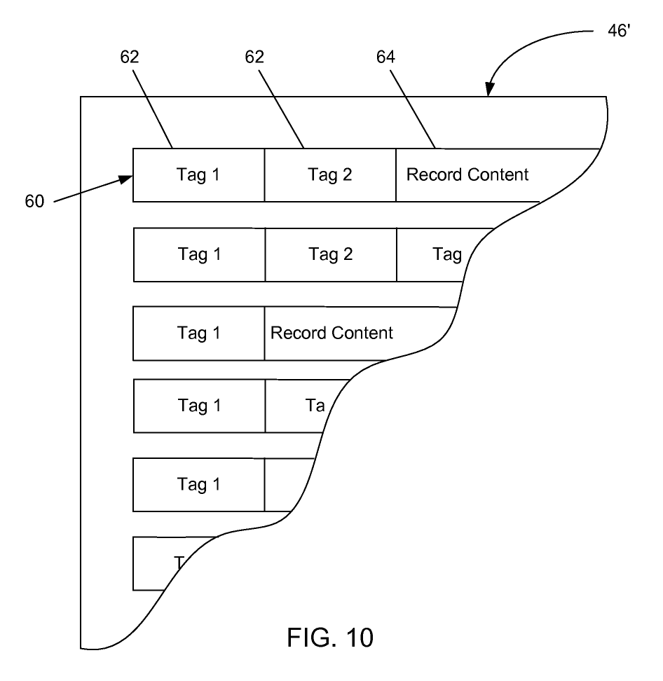

Referring now to FIG. 10, an alternate embodiment of a database/index, generally designated 46′, will be described. The database 46′ includes a plurality of records, generally designated 60. In the subject embodiment, the plurality of records 60 includes, but is not limited to, web records and advertisement records.

Each record 60 includes one or more tags 62 that represent categories that are associated with the record 60. In the subject embodiment, Tags 1 and 2 are categories that are associated with the record 60. The tags 62 can be selected from a variety of categories. Such categories include, but are not limited to, geography (e.g., California), time (e.g., 1940), topic (e.g., cars), event (e.g., wedding), demography (e.g., under 20 years old), schedule (e.g., open 24 hours), profession (e.g., attorney), food (e.g., corn), service (e.g., waterproofing), etc.

In some embodiments, the categories can also include sub-categories, and the categories can be defined in a hierarchy. For example, as disclosed in U.S. Pat. No. 5,930,474, which issued on Jul. 27, 1999 and is hereby incorporated by reference, the geographic tags 62 can be organized in a hierarchy such that the record 60 is tagged with the relevant geographic tags 62 such as country, state, city, neighborhood, etc.

The categories and associated tags described herein are examples only. Other categories can also be used. The numbers and types of categories and the respective tags can be refined to provide more or less precision for searches. For example, additional categories and sub-categories can be added over time to further refine the ability to identify content in the database. As the categories are made more precise, the user can select one or multiple tags associated with the desired categories to further refine the results that are returned to the user. In this manner, the results that are returned to the user can be more relevant to the user's query.

In some embodiments, the tags 62 can be associated with the record 60 using an automated process that analyzes the content of an indexed website or the content of the information provided by an advertiser. In other embodiments, the tags 62 can be manually added to the record 60. In yet other embodiments, the tags 62 can be added using a hybrid automated and manual process.

Record content 64 is the actual content of the record 60. For example, the record content 64 can be the information from a website that has been indexed in the database 46′. For example, the record content 64 can be created when the website is indexed in the database 46′.

In some embodiments, the record content 64 is created such that the website is indexed on a page-by-page basis. Internal web pages for a website can be assigned different tags 62 with different categories. In this manner, a query can identify specific internal web pages of a website that have relevant information for the user.

For example, a website located at a particular domain (e.g., www.geomas.com) can include multiple web pages, each with unique content. In example embodiments, each of these web pages associated with a domain can be indexed and tagged separately with a record, such as the record 60. This allows a user to input a desired category and to be directed to the specific page within the particular domain that is tagged with the relevant category.

The record content 64 can also be advertiser information. For example, information about an advertiser, such as contact information and information about the advertiser's goods/services, can be stored in the record content 64.

In the subject embodiment, both indexed content from a website and advertiser content is stored in the database 46′. A single record 60 is provided for both, so that any changes to that record 60 need only be made in one place. For example, if an entity has both a presence on the web, as well as wants to advertise to users, a single record 60 is created for the entity. The record 60 includes one or more tags 62 associated with the entity, as well as the record content 64, which is an index of the website associated with the entity, as well as advertisement information associated with the entity.

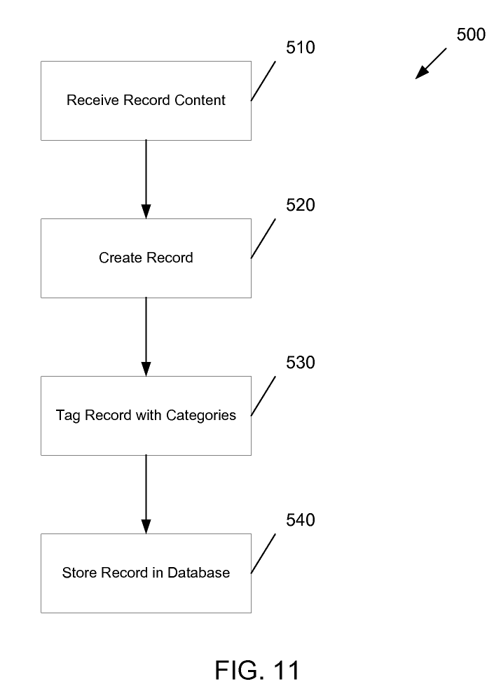

Referring now to FIG. 11, an example method 500 for creating a record 60 in the database 46′ is shown. At initial operation 510, the record content 64 is received. This record content 64 can include one or both of an index of a website and advertiser information. Next, at operation 520, the record 60 is created in the database 46′. Next, at operation 530, the record 60 is tagged with one or more relevant categories, using one or both of an automatic and manual process. Next, at operation 540, the record 60 is stored in the database 46′ for later retrieval.

The tags 62 associated with each record 60 allow the users to query the database 46′ to locate relevant websites and advertiser content. For example, the user can query the database 46′ by selecting one or more categories. Once the user provides a query with one or more categories, the database 46′ is queried and the records 60 having the tags identified by the query are delivered to the user. In some examples, the user can further refine a query by changing the categories provided to the database 46′. For example, the user can provide additional categories to refine the search results. Once the user's query is modified, new search results are delivered to the user.

The user can also query the database 46′ using keywords. For example, the user can use keywords in a Boolean or natural language query to further refine search results. If the user includes keywords in a query, the keywords are used to identify record content 64 that is relevant to the keywords. The record(s) 60 having the relevant record content 64 are then delivered to the user.

In other embodiments, the user provides a query including both categories and keywords. If such a query is provided, the database 46′ is first queried to identify those records 60 having tags that are relevant to the desired categories. Then this subset of records 60 is queried to identify record content 64 that is relevant to the keywords. The record(s) 60 in the relevant categories having the relevant record content 64 are then delivered to the user.

In some examples, the user can also define how the categories are applied to the search results to further refine the search results. For example, the user can define the sequence of the sort from major down to a minor category. The user can, for instance, choose a first category such as California (i.e., geography) as a major sort, and a second category such as cars (i.e., topic) as a minor sort.

If such a query is presented to the database 46′, the database 46′ locates only records 60 with a California geographic tag 62. Once all records 60 with the California tag 62 have been identified, the second sort of importance, “topic” (e.g. cars), can be performed on the subset of California records 60. Only records 60 that are tagged for California and cars are returned. Additional levels of refinement can be provided. The search logic can be defined such that the database 46′ is searched for the first and second sorts using a single query or multiple queries.

In example embodiments, the user can provide the categories and keywords to the database 46′ using a variety of methods. In one embodiment, the QEI 52 queries the user to assist the user in defining the one or more relevant categories that are used in the search. The QEI 52 can also allow the user to sequence the categories by order of importance. For example, the QEI 52 allows the user to pick from the available categories and sequence the categories in the order of importance. The categories and their sequencing can be set as a default, as well as for a one time query.

In other examples, the user can simply pick from different categories as part of creating the query that is sent to the database 46′. For example, the user can be provided with a hierarchy of categories, and the user can move through the hierarchy to identify one or more categories to include with the user's search, as well as the sequence of the categories. The user can also provide one or more keywords to include as part of the user's query.

In other example embodiments, the QEI 52 can maintain a historical record of the user's question and answer exchanges and can thereby automatically determine a sort sequence without the user's active involvement. If, as an example, in the past, the QEI 52 had asked the search user “What is more important to you, geography or topic?”, and the user answered “geography” 99% of the time, then the default sort sequence would automatically set the geography tag as the number one sort.

In the exampled described herein, the user has the flexibility to define the search parameters such that the search is conducted based on what is important to the user. For example, the user has the flexibility to define what categories and keywords are important to the user so that the resulting search identifies information that is relevant to the user.

In another embodiment, advertisers can target advertisements that are presented to the user. If, as an example, a user selects an event tag 62 such as “wedding” as number one in the sort sequence, advertisers for wedding services can be tagged with the same category so that the advertiser's advertisements can be presented to the user. The advertisements can be further refined based on additional tags 62 as well. For example, if the user selects an age tag 62 of “over 40” as second in the sort sequence, advertisers that specialize in wedding planning for older individuals can target their advertisement to this user.

In other examples, many service-oriented advertisers have a limited relevant geographic region in which to advertiser their services. For example, if the advertiser is a dentist and the pre-defined target market is no more than a five mile radius from the dentist's office, the dentist can associate its record 60 in the database 46′ with a geographic category and a profession category to better target advertisements to those users that are looking in the relevant geographic region and for the relevant services. Further, if the dentist does orthodontic work, the dentist can also associate an age tag 62 (e.g., “under 18”).

In some embodiments, the advertiser can also define the sequence of the categories. For example, if the advertiser is a restaurant that stays open past midnight, the restaurant can associate it's record in the database with tags 62 such as geography (e.g., city of “Norwood”), food (e.g., “hamburgers”), and time (e.g., “open 24 hours”). The advertiser can define the sequence of the tags 62 so that only queries that define the city as the primary sequence sort result in the advertiser's record being returned to the user. In this manner, the advertiser can control when its content is displayed to thereby target its audience. The restaurant can limit advertisement to users in a particular area first, so that the advertisement is not presented to users in other areas that are looking for hamburgers from restaurants open 24 hours a day.

In yet another example, the categories are organized into one or more standardized dictionaries with defined structures. For example, the structure can be broken into parts such as: 1) distinct advertising markets; 2) standardized categories; and 3) standardized profiles. Each dictionary can span multiple languages and can be tailored for distinct geo-based advertising markets. The underlying code database structure (see, e.g., FIG. 10) can be standardized to accommodate multiple languages, profiles, and databases.

In such an example, the advertiser can define standardized profiles of desired customers at the advertiser's website using specific tags. The profiles can be associated with the advertiser's website in a manner similar to metatags, such that the profiles are accessible on the website when the website is accessed. In this manner, the profiles can be crawled by the search engine 48 as the search engine 48 indexes the advertiser's website, and the profiles can be stored in the database/index 46.

In such a configuration, the profiles can be used by the search engine 48 as users conduct searches. For example, the search engine 48 can use the profiles to match queries to particular advertisers as the users conduct queries and present information about the advertiser's website and/or products/services as part of the search results or advertisements surrounding the search results. Since the advertiser is able to define profiles of potential customers in a standardized format, the matching of the potential customer to the advertiser is optimized. In this manner, the search engine can be optimized to match the user who is looking to purchase a specific product or service with the advertiser that is looking to sell that same specific product or service. The results and advertisements presented to the user can therefore be tied directly to the transaction the user is trying to perform.

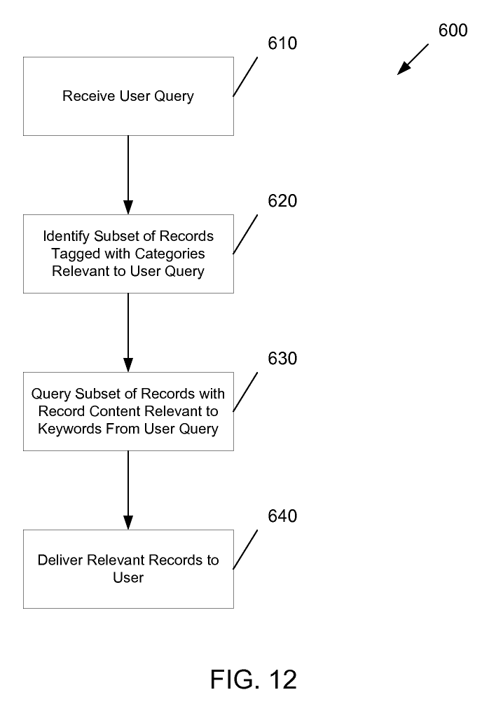

Referring now to FIG. 12, an example method 600 is shown for querying the database 46′. At initial operation 610, the user's query is received. Next, at operation 620, the subset of records in the database 46′ that is tagged with the categories in the user's query is identified. Next, at operation 630, the record content 64 of the subset of records 60 is queried based on the keywords provided in the user query to identify those records 60 of the subset that are relevant to the user's keywords. Finally, at operation 640, the information pertaining to the relevant records 60 is delivered to the user.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. A method for refining a query to a database on a host system, the method comprising:
receiving a query from a client system;
submitting at least one question to the client system based on information provided in the query;
receiving an answer to the question from the client system;
refining the query based on the answer received from the client system; and
querying the database using the refined query.

2. The method of claim 1, further comprising:
identifying a subset of records tagged with categories relevant to the query; and
querying the subset of records having record content relevant to the query.

3. The method of claim 2, further comprising delivering search results to the client system.

4. The method of claim 2, further comprising organizing the categories into a hierarchy.

5. The method of claim 4, further comprising organizing the hierarchy based, at least in part, on geography.

6. The method of claim 1, further comprising:
submitting multiple sequential questions to the client system based on information provided in the query;
receiving multiple answers to the multiple sequential questions from the client system;

7. The method of claim 6, further comprising continuing to send sequential questions to the client system until search results are adequate.

8. A method for refining a search query, the method comprising:
receiving a query from a user;
submitting at least one question to the user based on information provided in the query;
receiving an answer to the question from the user;
refining the query based on the answer received from the user;
querying the database using the refined query to identify a subset of records tagged with categories relevant to the query; and
delivering search results to the user.

9. The method of claim 8, further comprising querying the subset of records having record content relevant to the query.

10. The method of claim 8, further comprising organizing the categories into a hierarchy.

11. The method of claim 10, further comprising organizing the hierarchy based, at least in part, on geography.

12. The method of claim 8, further comprising:
submitting multiple sequential questions to the user based on information provided in the query; and
receiving multiple answers to the multiple sequential questions from the user.

13. The method of claim 12, further comprising continuing to send sequential questions to the user until search results are adequate.

14. A computer-readable medium storage medium on which is stored computer executable instructions which, when executed by a computing device, cause the computing device to perform a method for refining a search query, comprising:
receiving a query from a user;
submitting at least one question to the user based on information provided in the query;
receiving an answer to the question from the user;
refining the query based on the answer received from the user;
querying the database using the refined query to identify a subset of records tagged with categories relevant to the query; and
delivering search results to the user.

15. The computer-readable storage medium of claim 14, further comprising querying the subset of records having record content relevant to the query.

16. The computer-readable storage medium of claim 14, further comprising organizing the categories into a hierarchy.

17. The computer-readable storage medium of claim 16, further comprising organizing the hierarchy based, at least in part, on geography.

18. The computer-readable storage medium of claim 14, further comprising:
submitting multiple sequential questions to the user based on information provided in the query; and
receiving multiple answers to the multiple sequential questions from the user.

19. The computer-readable storage medium of claim 18, further comprising continuing to send sequential questions to the user until search results are adequate.

20. The computer-readable storage medium of claim 14, further comprising:
accessing profiles defined by one or more advertisers on the advertiser's websites;
storing the profiles defined by the advertisers; and
using the profiles to associate the query to one or more of the advertisers.
